(19) United States
(12) Patent Application Publication
(10) Pub. No.: US 2020/0073953 A1
(43) Pub. Date: Mar. 5, 2020

(54) Ranking Entity Based Search Results Using User Clusters

(71) Applicant: salesforce.com, inc., San Francisco, CA (US)

(72) Inventor: Swapnil Sanjay Kulkarni, San Francisco, CA (US)

(21) Appl. No.: 16/118,410

(22) Filed: Aug. 30, 2018

(51) Int. Cl. G06F 17/30; G06N 3/04; G06N 3/08

(52) U.S. Cl. CPC G06F 17/3053; G06F 17/30554; G06N 3/08; G06N 3/04; G06F 17/30598

(57) ABSTRACT

A system stores records of different entity types and processes search queries to determine search results comprising records that match the search query. The system determines clusters of users based on feature vectors describing the users. A feature vector may be extracted from a hidden layer of a neural network. The system identifies a user that provided a search query and identifies a cluster of users matching the user. The system retrieves a set of weights for the cluster of users and uses the set of weights to rank the search results. The set of weights may represent relevance scores corresponding to various entity types. The system returns the ranked search results.

### BACKGROUND

### Field of Art

The disclosure relates in general to ranking search results and in particular to performing ranking of entity based search results using user clusters.

### Description of the Related Art

Online systems used by enterprises, organizations, and businesses store large amounts of information. These systems allow users to perform searches. An online system deploys a search engine that identifies records matching a search query, scores the search results using various signals, and returns a list of ranked search results. Search engines typically rank search results based on criteria such as the frequency with which search terms occur within documents, popularity of documents, portions of documents where the keywords occur, and so on.

The search engine ranks search results in an order that indicates a relevance of each search result for the users. For example, a popular document may appear higher in the search results compared to a document that very few users have accessed in the past. However, different users may be interested in different types of results. For example, two users may search for the same topic, but one user may be interested in latest news related to the topic whereas another user may be interested in literature describing that topic. Search engines that provide the same search results to all users often provide results that may not be relevant to at least some of the users. As a result, the search engine provides poor user experience to these users.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1A shows an overall system environment illustrating an online system receiving search requests from clients and processing them, according to an embodiment.

FIG. 1B show an overall system environment illustrating an online system receiving search requests from clients and processing them, according to another embodiment.

FIG. 2A shows the system architecture of a search module, according to an embodiment.

FIG. 2B shows the system architecture of a search service module, according to another embodiment.

FIG. 3A shows the system architecture of a client application, according to an embodiment.

FIG. 3B shows the system architecture of a client application, according to another embodiment.

FIG. 4 shows a diagram of an example neural network, according to an embodiment.

FIG. 5 shows an example system architecture of a neural network module for generating feature vectors describing users, according to an embodiment.

FIG. 6 illustrates a process for generating user clusters, according to an embodiment.

FIG. 7 illustrates the process of ranking search results based on user clusters, according to an embodiment.

FIG. 8 shows a high-level block diagram of a computer for processing the methods described herein, according to an embodiment.

Reference will now be made in detail to several embodiments, examples of which are illustrated in the accompanying figures. It is noted that wherever practicable similar or like reference numbers may be used in the figures and may indicate similar or like functionality.

The figures depict embodiments of the disclosed system (or method) for purposes of illustration only. One skilled in the art will readily recognize from the following description that alternative embodiments of the structures and methods illustrated herein may be employed without departing from the principles described herein.

### DETAILED DESCRIPTION

### System Overview

An online system receives a search request that invokes the search engine to deliver most relevant search results for the given query. The online system identifies a user that sent the search request. The online system stores clusters of users that represent similar users based on a matching of feature vectors representing the users. The online system stores a set of weights for each cluster of users. The set of weights are used for ranking search results. The online system identifies a cluster of user that is closest to the user that sent the search request. The online system retrieves the set of weights for the matching cluster of users. The online system ranks the search results based on the set of weights. The online system returns the ranked search results to the client application which then constructs and presents a search results page to the user. The user interacts with the search results page. User interaction data is captured by the client application and is sent back to the online system to improve search relevance for subsequent searches. Historical search queries and user's interactions with their search results are a strong signal for search relevance. The online system may re-compute the set of weights associated with various user clusters based on the feedback obtained from the search result pages. The search engine can rank search results from these revised set of weights, for example, for subsequent search requests.

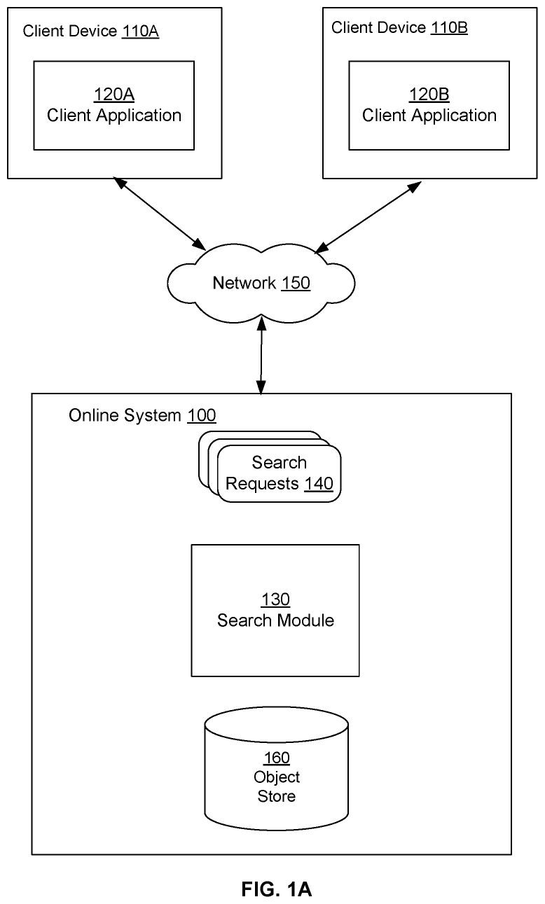

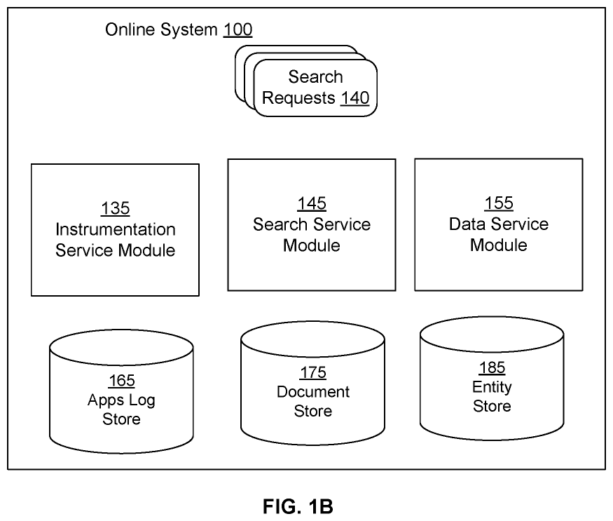

FIG. 1A show an overall system environment illustrating an online system receiving search requests from clients and processing them, in accordance with an embodiment. As shown in FIG. 1A, the overall system environment includes an online system 100, one or more client devices 110, and a network 150. Other embodiments may use more or fewer or different systems than those illustrated in FIG. 1A. Functions of various modules and systems described herein can be implemented by other modules and/or systems than those described herein.

FIG. 1A and the other figures use like reference numerals to identify like elements. A letter after a reference numeral, such as “120A,” indicates that the text refers specifically to the element having that particular reference numeral. A reference numeral in the text without a following letter, such as “120,” refers to any or all of the elements in the figures bearing that reference numeral (e.g. “120” in the text refers to reference numerals “120A” and/or “120B” in the figures).

A client device 110 is used by users to interact with the online system 100. A user interacts with the online system 100 using client device 110 executing client application 120. An example of a client application 120 is a browser application. In an embodiment, the client application 120 interacts with the online system 100 using HTTP requests sent over network 150.

The online system 100 includes an object store 160 and a search module 130. The online system 100 receives search requests 140 from users via the client devices 110. The object store 160 stores data represented as objects. An object may represent a document, for example, a knowledge article, an FAQ (frequently asked question) document, a manual for a product, and so on. An object may also represent an entity associated with an enterprise, for example, an entity of entity type opportunity, case, account, and so on. An entity may also be referred to as a record or a tuple comprising a set of values. In general, search results comprise object that may be documents or entities. Accordingly, search results for a search query may include documents, entities, or a combination of both.

A search request 140 specifies search criteria, for example, a search query comprising search terms/keywords, logical operators specifying relations between the search terms, details about facets to retrieve, additional filters like size, scope, ordering, and so on. The search module 130 processes the search requests 140 and determines search results comprising documents/entities that match the search criteria specified in the search request 140. The search module 130 ranks the search results based on a measure of likelihood that the user is interested in each search result. The search module 130 sends the ranked search results to the client device 110. The client device 110 presents the search results based on the ranking, for example, in descending order with higher ranked search results occupying a higher position in the order.

The search module 130 uses features extracted from search results to rank the search results. In an embodiment, the search module 130 determines a relevance score for each search result based on a weighted aggregate of the features describing the search result. Each feature is weighted based on a feature weight associated with the feature. The search module 130 adjusts the feature weights to improve the ranking of search results.

In an embodiment, the search module 130 modifies the feature weights and measures the impact of the modification by applying the new feature weights to past search requests and analyzing the newly ranked results. The online system stores information describing past search requests. The stored information comprises, for each stored search request, the search request and the set of search results returned in response to the search request.

The online system 100 monitors which results were of interest to the user based on user interactions responsive to the user being presented with the search results. Accordingly, if the online system receives a data access request for a given search result, the online system 100 marks the given search result as an accessed search result. In an embodiment, the online system collects statistical information describing the entity types corresponding to the search results that the users accessed. The online system 100 determine based on the statistical information a measure of likelihood of a user accessing an entity or record of a particular entity type responsive to being presented with a set of search results of various entity types. The online system 100 determines an aggregate measure of a likelihood of a user belonging to a cluster of users accessing entities of a particular entity type.

The search module 130 adjusts the feature weights to measure if the ranks of the accessed search results improve. Accordingly, the search module 130 may try a plurality of different feature weight combinations to find a particular feature weight combination that results in the optimal ranking of accessed search results. The search module 130 determines that a ranking based on a first set of feature weights is better than a ranking based on a second set of feature weights if the accessed results are ranked higher on average based on the first set of feature weights compared to the second set of feature weights.

In some embodiments, an online system 100 stores information of one or more tenants to form a multi-tenant system. Each tenant may be an enterprise as described herein. As an example, one tenant might be a company that employs a sales team where each salesperson uses a client device 110 to manage their sales process. Thus, a user might maintain contact data, leads data, customer follow-up data, performance data, goals, and progress data, etc., all applicable to that user's personal sales process.

In one embodiment, online system 100 implements a web-based customer relationship management (CRM) system. For example, in one embodiment, the online system 100 includes application servers configured to implement and execute CRM software applications as well as provide related data, code, forms, webpages and other information to and from client devices 110 and to store to, and retrieve from, a database system related data.

With a multi-tenant system, data for multiple tenants may be stored in the same physical database, however, tenant data typically is arranged so that data of one tenant is kept logically separate from that of other tenants so that one tenant does not have access to another tenant's data, unless such data is expressly shared. In certain embodiments, the online system 100 implements applications other than, or in addition to, a CRM application. For example, the online system 100 may provide tenant access to multiple hosted (standard and custom) applications, including a CRM application. According to one embodiment, the online system 100 is configured to provide webpages, forms, applications, data and media content to client devices 110. The online system 100 provides security mechanisms to keep each tenant's data separate unless the data is shared.

A multi-tenant system may implement security protocols and access controls that keep data, applications, and application use separate for different tenants. In addition to user-specific data and tenant-specific data, the online system 100 may maintain system level data usable by multiple tenants or other data. Such system level data may include industry reports, news, postings, and the like that are sharable among tenants.

It is transparent to customers that their data may be stored in a database that is shared with other customers. A database table may store rows for a plurality of customers. Accordingly, in a multi-tenant system, various elements of hardware and software of the system may be shared by one or more customers. For example, the online system 100 may execute an application server that simultaneously processes requests for a number of customers.

In an embodiment, the online system 100 optimizes the set of features weights for each tenant of a multi-tenant system. This is because each tenant may have a different usage pattern for the search results. Accordingly, search results that are relevant for a first tenant may not be very relevant for a second tenant. Therefore, the online system determines a first set of feature weights for the first tenant and a second set of feature weights for the second tenant.

The online system 100 and client devices 110 shown in FIG. 1A can be executed using computing devices. A computing device can be a conventional computer system executing, for example, a Microsoft™ Windows™-compatible operating system (OS), Apple™ OS X, and/or a Linux distribution. A computing device can also be a client device having computer functionality, such as a personal digital assistant (PDA), mobile telephone, etc. The online system 100 stores the software modules storing instructions, for example search module 130.

The interactions between the client devices 110 and the online system 100 are typically performed via a network 150, for example, via the Internet. In one embodiment, the network uses standard communications technologies and/or protocols. In another embodiment, various devices, and systems can use custom and/or dedicated data communications technologies instead of, or in addition to, the ones described above. The techniques disclosed herein can be used with any type of communication technology, so long as the communication technology supports receiving by the online system 100 of requests from a sender, for example, a client device 110 and transmitting of results obtained by processing the request to the sender.

FIG. 1B show an overall system environment illustrating an online system receiving search requests from clients and processing them, in accordance with another embodiment. As shown in FIG. 1B, the online system includes an instrumentation service module 135, a search service module 145, a data service module 155, an apps log store 165, a document store 175, and an entity store 185. The functionality of modules shown in FIG. 1B may overlap with the functionality of modules shown in FIG. 1A.

The online system 100 receives search requests 140 having different search criteria from clients. The search service module 145 executes searches and returns the most relevant results matching search criteria received in the search query.

The instrumentation service module 135 is a logging and monitoring module that receives logging events from different clients. The instrumentation service module 135 validates these events against pre-defined schemas. The instrumentation service module 135 may also enrich events with additional metadata like user id, session id, etc. Finally, the instrumentation service module 135 publishes these events as log lines to the app logs store 165.

The data service module 155 handles operations such as document and entity create, view, save and delete. It may also provide advanced features such as caching and offline support.

The apps log store 165 stores various types of application logs. Application logs may include logs for both clients as well different modules of the online system itself.

The entity store 185 stores details of entities supported by an enterprise. Each entity is associated with an entity type. Accordingly, an entity is an instance of a particular entity type. For example, a particular contact having id=123, first name=“Joe”, last name=“Smith, phone=555-1234, and so on represents a particular entity of entity type contact. Entities may represent an individual account, which is an organization or person involved with a particular business (such as customers, competitors, and partners). It may represent a contact, which represents information describing an individual associated with an account. It may represent a customer case that tracks a customer issue or problem, a document, a calendar event, and so on.

Each entity has a well-defined schema describing its fields. For example, an account may have an id, name, number, industry type, billing address etc. A contact may have an id, first name, last name, phone, email etc. A case may have a number, account id, status (open, in-progress, closed) etc. Entities might be associated with each other. For example, a contact may have a reference to account id. A case might include references to account id as well as contact id.

The document store 175 stores one or more documents of supported entity types. It could be implemented as a traditional relational database or NoSQL database that can store both structured and unstructured documents.

### System Architecture

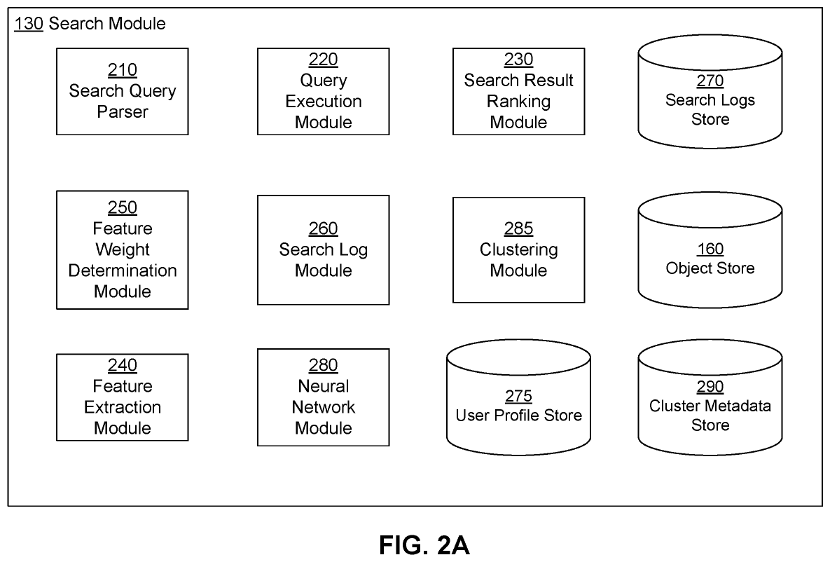

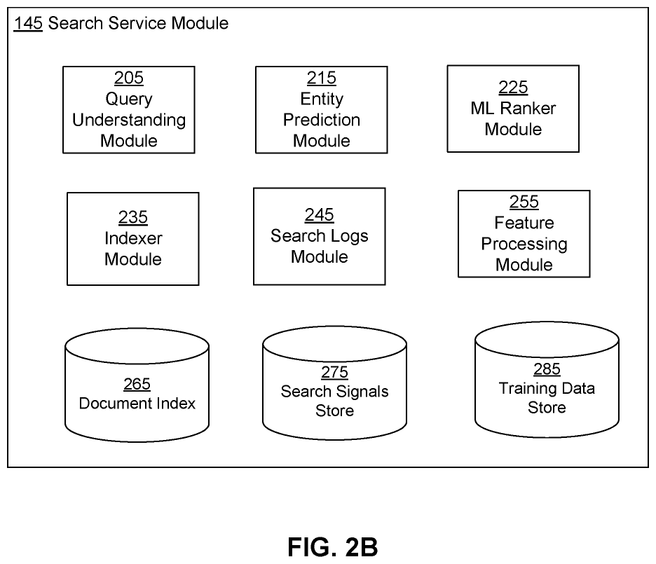

FIG. 2A shows the system architecture of a search module, in accordance with an embodiment. The search module 130 comprises a search query parser 210, a query execution module 220, a search result ranking module 230, a search log module 260, a feature extraction module 240, a feature weight determination module 250, a user profile store 275, a neural network module 280, a clustering module 285, a search logs store 270, and the object store 160. Other embodiments may include more or fewer modules. Functionality indicated herein as being performed by a particular module may be performed by other modules.

The object store 160 stores entities associated with an enterprise. The object store 160 may also store documents, for example, knowledge articles, FAQs, manuals, and so on. An enterprise may be an organization, a business, a company, a club, or a social group. An entity has an entity type, for example, account, a contact, a lead, an opportunity, and so on. The term “entity” may also be used interchangeably herein with “object”.

An entity may represent an account representing a business partner or potential business partner (e.g. a client, vendor, distributor, etc.) of a user, and may include attributes describing a company, subsidiaries, or contacts at the company. As another example, an entity may represent a project that a user is working on, such as an opportunity (e.g. a possible sale) with an existing partner, or a project that the user is trying to get. An entity may represent an account representing a user or another entity associated with the enterprise. For example, an account may represent a customer of the first enterprise. An entity may represent a user of the online system.

In an embodiment, the object store 160 stores an object as one or more records. An object has data fields that are defined by the structure of the object (e.g. fields of certain data types and purposes). For example, an object representing an entity may store information describing the potential customer, a status of the opportunity indicating a stage of interaction with the customer, and so on. An object representing an entity of entity type case may include attributes such as a date of interaction, information identifying the user initiating the interaction, description of the interaction, and status of the interaction indicating whether the case is newly opened, resolved, or in progress.

The object store 160 may be implemented as a relational database storing one or more tables. Each table contains one or more data categories logically arranged as columns or fields. Each row or record of a table contains an instance of data for each category defined by the fields. For example, an object store 160 may include a table that describes a customer with fields for basic contact information such as name, address, phone number, fax number, etc. Another table might describe a purchase order, including fields for information such as customer, product, sale price, date, etc.

The search query parser 210 parses various components of a search query. The search query parser 210 checks if the search query conforms to a predefined syntax. The search query parser builds a data structure representing information specified in the search query. For example, the search query parser 210 may build a parse tree structure based on the syntax of the search query. The data structure provides access to various components of the search query to other modules of the online system 100.

The query execution module 220 executes the search query to determine the search results based on the search query. The search results determined represent the objects stored in the object store 160 that satisfy the search criteria specified in the search query. In some embodiments, the query execution module 220 develops a query plan for executing a search query. The query execution module 220 executes the query plan to determine the search results that satisfy the search criteria specified in the search query. As an example, a search query may request all entities of a particular entity type that include certain search terms, for example, all entities representing cases that contain certain search terms. The query execution module 220 identifies entities of the specified entity type that include the search terms as specified in the search criteria of the search query. The query execution module 220 provides a set of identified entities, to the feature extraction module 240.

The feature extraction module 240 extracts features of the entities from the identified set of entities and provides the extracted features to the feature weight determination module 250. In an embodiment, the feature extraction module 240 represents a feature using a name and a value. The features describing the entities may depend on the entity type. Some features may be independent of the entity type and apply to all entity types. Examples of features extracted by the feature extraction module 240 include a time of the last modification of an entity or the age of the last modification of the entity determined based of the length of time interval between the present time and the last time of modification.

The feature extraction module 240 extracts entity type specific features from certain entities. For example, if an entity represents an opportunity or a potential transaction, the feature extraction module 240 extracts a feature indicating whether an entity representing an opportunity is closed or a feature indicating an estimate of time when the opportunity is expected to close. As another example, if an entity represents a case, feature extraction module 240 extracts features describing the status of the case, status of the case indicating whether the case is a closed case, an open case, an escalated case, and so on. In an embodiment, a feature associated with an entity of a particular entity type is a weight associated with the entity type. The weight may be determined for each cluster of users. The weight of an entity type indicates the likelihood of the user interacting with the search result of that entity type.

The feature weight determination module 250 determines weights for features and assigns scores for features of search results by the query execution module 220. Different features have different contribution to the overall measure of relevance of the search result. The differences in relevance among features of a search result with regards to a search request 140 are represented as weights. Each feature of each determined search result is scored according to its relevance to search criteria of the search request, then those scores are weighted and combined to create a relevance score for each search result. In an embodiment, the feature weights are determined for each user cluster and stored as metadata for that user cluster. Accordingly, the weights for a user cluster C1 may be different from the weights for a user cluster C2. The online system ranks the search result for a search query received from a user based on the feature weights of the cluster of users matching the user.

Feature weights may be determined by analysis of search result performance and training models. This can be done using machine learning. Dimensionality reduction (e.g., via linear discriminant analysis, principle component analysis, etc.) may be used to reduce Machine learning algorithms used include support vector machines (SVMs), boosting for other algorithms (e.g., AdaBoost), neural net, logistic regression, naive Bayes, memory-based learning, random forests, bagged trees, decision trees, boosted trees, boosted stumps, etc. In an embodiment, the online system trains a machine learning for each cluster of users and uses the machine learning model for a user providing the search query for ranking the search results matching that search query.

Random forest classification based on predictions from a set of decision trees may be used to train a model. Each decision tree splits the source set into subsets based on an attribute value test. This process is repeated in a recursive fashion. A decision tree represents a flow chart, where each internal node represents a test on an attribute. For example, if the value of an attribute is less than or equal to a threshold value, the control flow transfers to a first branch and if the value of the attribute is greater than the threshold value, the control flow transfers to a second branch. Each branch represents the outcome of a test. Each leaf node represents a class label, i.e., a result of a classification.

Each decision tree uses a subset of the total predictor variables to vote for the most likely class for each observation. The final random forest score is based on the fraction of models voting for each class. A model may perform a class prediction by comparing the random forest score with a threshold value. In some embodiments, the random forest output is calibrated to reflect the probability associated with each class.

The weights of features for predicting relevance of different search requests with different sets of search criteria and features may be different. Accordingly, a different machine learning model may be trained for each cluster of similar users and applied to search queries received from users matching the cluster of user. In an embodiment, the information identifying the search result that was accessed by a user belonging to a cluster is provided as a labeled training dataset for training the machine learning model corresponding to that cluster of users.

A factor which impacts the weight of a feature vector, or a relevance score overall, is user interaction with the corresponding search result. If a user selects one or more search results for further interaction, those search results are deemed relevant to the search request, and therefore the system records those interactions and uses those stored records to improve search result ranking for the subsequent search requests.

The search result ranking module 230 ranks search results determined by the query execution module 220 for a given search query. For example, the online system may perform this by applying a ranking model stored for a cluster of users, to the features of each search result and thereafter sorting the search results in descending order of relevance score. Factors such as search result interaction, also impact the ranking of each search result. Search results which have been interacted with for a given search request are ranked higher than other search results for similar search requests.

In one embodiment, entity type is one of the features used for determining relevance of search results for ranking them. For a cluster of users, the online system determines, for each entity type that may be returned as a search result, a weight based on an aggregate number of user interactions with search results of that entity type. Accordingly, the online system weighs search results of certain entity types as more relevant than search results of other entity types for that cluster of users. Accordingly, when the online system receives a search request, the online system ranks the search results with entity types rated more relevant higher than search results with entity types rated less relevant.

The search log module 260 stores information describing search requests, also known as search queries, processed by the online system 100 in search logs store 270. The search log module 260 stores the search query received by the online system 100 as well as information describing the search results identified in response to the search query. The search log module 260 also stores information identifying accessed search results. An accessed search result represents a search result for which the online system receives a request for additional information responsive to providing the search results to a requestor. For example, the search results may be presented to the user via the client device 110 such that each search result displays a link providing access to the entity represented by the search result. Accordingly, a result is an accessed result if the user clicks on the link presented with the result.

In an embodiment, the search logs store 270 stores the information in a file, for example, as a tuple comprising values separated by a separator token such as a comma. In another embodiment, the search logs store 270 is a relational database that stores information describing searches as tables or relations.

The user profile store 275 stores user profile information for users of the online system 100. The user profile information may be represented as user profile attributes. A user profile attribute represents a role of the user in an organization. The organization may be associated with a hierarchy of roles. Examples of roles include a manager, an individual contributor, an executive, a technical support person, a customer service representative, and so on. A user profile attribute stores information describing the entity types that are commonly accessed by the user. For example, the user profile attribute may store a score for each entity type, the score indicating a likelihood of the user accessing a record of that entity type responsive to being presented with records of different entity types, for example, as search results. The score may be determined based on statistical information collected from past search queries provided by the user and the entity types of search results that the user accessed. The score may be determined based on the entity types that the user accesses during interactions with the online system. For example, a sales representative may access records of entity type “opportunity” more frequently compared to a human resources person who accesses records of “employee information” more frequently. Other user profile attributes include age, gender, salary range, location, and languages spoken.

The clustering module 285 performs clustering of user profiles based on feature vectors describing the user profile, referred to as user feature vectors. In an embodiment, the user feature vectors represent the user profile attributes such that each feature of the user feature vector stores a value determined from a particular user profile attribute. In another embodiment, the user feature vector is extracted from a neural network that is configured to receive an encoding of the user profile attributes. The user feature vector is extracted as an embedding representing an output of a hidden layer of the neural network. The clustering module performs clustering to determine clusters of uses that have similar user profiles. In an embodiment, the clustering module executes a k-means clustering algorithm for clustering the user feature vectors. Other embodiments may execute other clustering algorithms. In an embodiment, the clustering module 285 treats each feature of the feature vector as a dimension. Accordingly, the clustering module 285 represents each feature vector as a data point in a multi-dimensional space of a plurality of dimensions, each dimension corresponding to a feature. The distance between two data points in the multi-dimensional space provides a measure of similarity between two feature vectors corresponding to the two data points. Accordingly, two data points that are close to each other represent more similar feature vectors compared to two data points that are further apart. Accordingly, a measure of similarity between two data points is inversely related to the distance between the two data points.

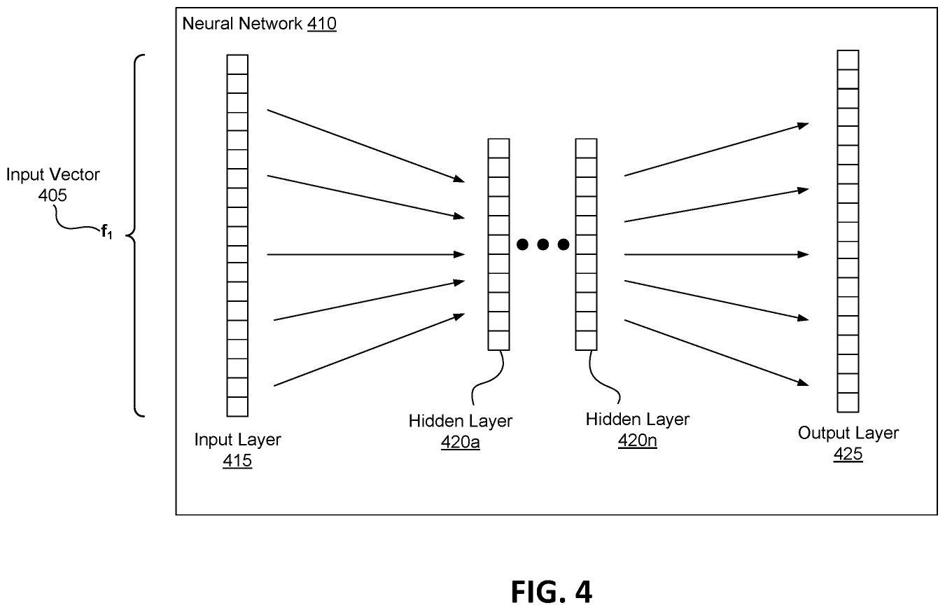

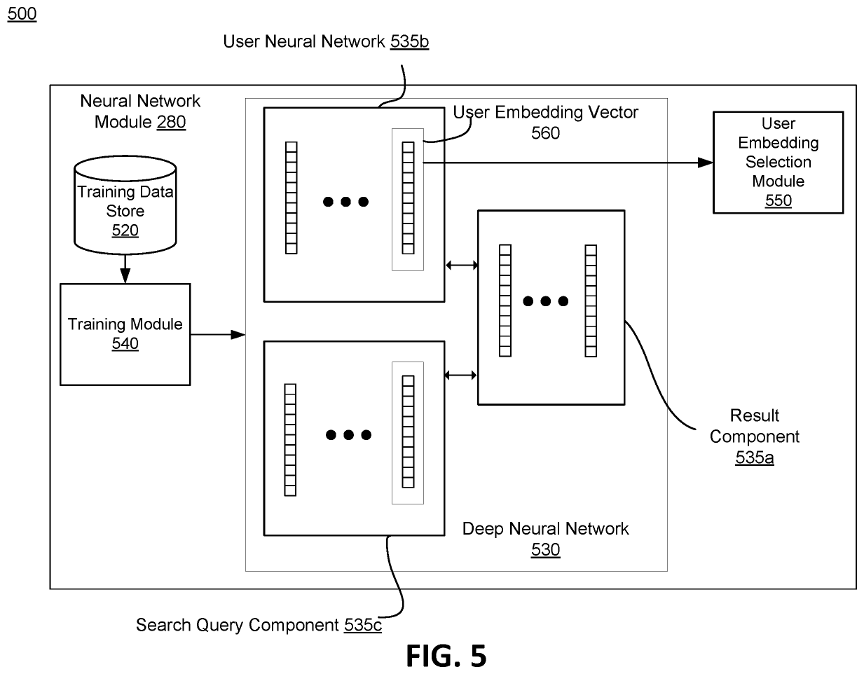

The clustering module 285 identifies clusters of feature vector such that feature vectors belonging to a cluster are closer to each other as compared to feature vectors outside the cluster. The clustering module 285 can use various clustering techniques, for example, centroid-based clustering (e.g., k-means clustering), distribution-based clustering, density-based clustering (e.g., mean-shift clustering), and so on. The neural network module 280 is further described in connection with FIGS. 4 and 5. The clustering module 285 stores information describing the clusters in the cluster metadata store 290. Information describing a cluster includes a cluster identifier and statistical information describing aggregate feature vectors for the cluster. The cluster metadata store 290 stores a set of weights corresponding to each cluster of users. The set of weights is used for ranking search results in a manner that is specific to each cluster of users.

FIG. 2B shows the system architecture of a search service module 145, in accordance with another embodiment. The search service module 145 includes a query understanding module 205, an entity prediction module 215, a machine learning (ML) ranker module 225, an indexer module 235, a search logs module 245, a feature processing module 255, a document index 265, a search signals store 275, and a training data store 285. Other embodiments may include other modules in the search service module 145.

The query understanding module 205 determines what the user is searching for, i.e., the precise intent of the search query. It corrects an ill-formed query. It refines queries by applying techniques such as spell correction, reformulation and expansion. Reformulation includes application of alternative words or phrases to the query. Expansion includes sending more synonyms of the words. It may also send morphological words by stemming.

Furthermore, the query understanding module 205 performs query classification and semantic tagging. Query classification represents classifying a given query in a predefined intent class (also referred to herein as a cluster of similar queries.). For example, the query understanding module 205 may classify “curry warriors san francisco” as a sports related query.

Semantic tagging represents identifying the semantic concepts of a word or phrase. The query understanding module 205 may determine that in the example query, “curry” represents a person's name, “warriors” represents a sports team name, and “san francisco” represents a location.

The entity prediction module 215 predicts which entity the user is most likely to access from the search results of a search query. In some embodiments, the entity prediction module 215 may be merged into query understanding module.

Entity prediction is based on machine learning (ML) algorithm which computes probability score for each entity for given query. This ML algorithm generates a model based on a set of features. This model is trained offline using training data stored in training data store 285.

The features used by the ML model can be broadly divided into following categories: (1) Query level features or search query features: These features depend only on the query. While training, the entity prediction module 215 builds an association matrix of queries to identify similar set of queries. It extracts click and hover information from these historical queries. This information serves as a primary distinguishing feature.

The ML ranker module 225 is a machine-learned ranker module. Learning to rank or machine-learned ranking (MLR) is the application of machine learning in the construction of ranking models for information retrieval systems.

There are several standard retrieval models such as TF/IDF and BM25 that are fast enough to be produce reasonable results. However, these methods can only make use of very limited number of features. In contrast, MLR system can incorporate hundreds of arbitrarily defined features.

Users expect a search query to complete in a short time (such as a few hundred milliseconds), which makes it impossible to evaluate a complex ranking model on each document in a large corpus, and so a multi-phase scheme can be used.

Level-1 Ranker: top-K retrieval first, a small number of potentially relevant documents are identified using simpler retrieval models which permit fast query evaluation, such as the vector space model (TF/IDF) and BM25, or a simple linear ML model. This ranker is completely at individual document level, i.e. given a (query, document) pair, assign a relevance score.

Level-2 Ranker: In the second phase, a more accurate but computationally expensive machine-learned model is used to re-rank these documents. This is where heavy-weight ML ranking takes place. This ranker takes into consideration query classification and entity prediction external features from query understanding module and entity prediction module respectively.

The level-2 ranker may be computationally expensive due to various factors like it may depend upon certain features that are computed dynamically (between user, query, documents) or it may depend upon additional features from external system. Typically, this ranker operates on a large number of features, such that collecting/sending those features to the ranker would take time. ML Ranker is trained offline using training data. It can also be further trained and tuned with live system using online A/B testing.

The training data store 285 stores training data that typically consists of queries and lists of results. Training data may be derived from search signals store 275. Training data is used by a learning algorithm to produce a ranking model which computes relevance of results for actual queries.

The feature processing module 255 extracts features from various sources of data including user information, query related information, and so on. For ML algorithms, query-document pairs are usually represented by numerical vectors, which are called feature vectors. Components of such vectors are called features or ranking signals.

Features can be broadly divided into following categories:

(1) Query-independent or static features: These features depend only on the result document, not on the query. Such features can be precomputed in offline mode during indexing. For example, document lengths and IDF sums of document's fields, document's static quality score (or static rank), i.e. document's PageRank, page views and their variants and so on.

(2) Query-dependent or dynamic features: These features depend both on the contents of the document, the query, and the user context. For example, TF/IDF scores and BM25 score of document's fields (title, body, anchor text, URL) for a given query, connection between the user and results, and so on.

(3) Query level features or search query features: These features depend only on the query. For example, the number of words in a query, or how many times this query has been run in the last month and so on.

The feature processing module 255 includes a learning algorithm that accurately selects and stores subset of very useful features from the training data. This learning algorithm includes an objective function which measures importance of collection of features. This objective function can be optimized (maximization or minimization) depending upon the type of function. Optimization to this function is usually done by humans.

The feature processing module 255 excludes highly correlated or duplicate features. It removes irrelevant and/or redundant features that may produce discriminating outcome. Overall this module speeds up learning process of ML algorithms.

The search logs module 245 processes raw application logs from the app logs store by cleaning, joining and/or merging different log lines. These logs may include: (1) Result click logs—The document id, and the result's rank etc. (2) Query logs—The query id, the query type and other miscellaneous info. This module produces a complete snapshot of the user's search activity by joining different log lines. After processing, each search activity is stored as a tuple comprising values separated by a token such as comma. The data produced by this module can be used directly by the data scientists or machine learning pipelines for training purposes.

The search signals store 275 stores various types of signals that can be used for data analysis and training models. The indexer module 235 collects, parses, and stores document indexes to facilitate fast and accurate information retrieval.

The document index 265 stores the document index that helps optimize speed and performance in finding relevant documents for a search query. Without an index, the search engine would scan every document in the corpus, which would require considerable time and computing power. For example, while an index of 10,000 documents can be queried within milliseconds, a sequential scan of every word in 10,000 large documents could take hours.

The document index 265 may be an inverted index that helps evaluation of a search query by quickly locating documents containing the words in a query and then ranking these documents by relevance. Because the inverted index stores a list of the documents containing each word, the search engine can use direct access to find the documents associated with each word in the query in order to retrieve the matching documents quickly.

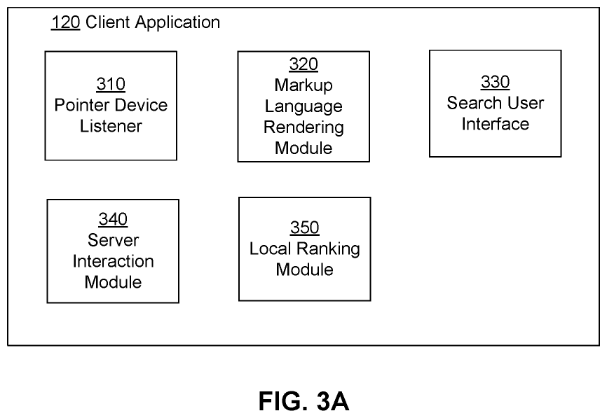

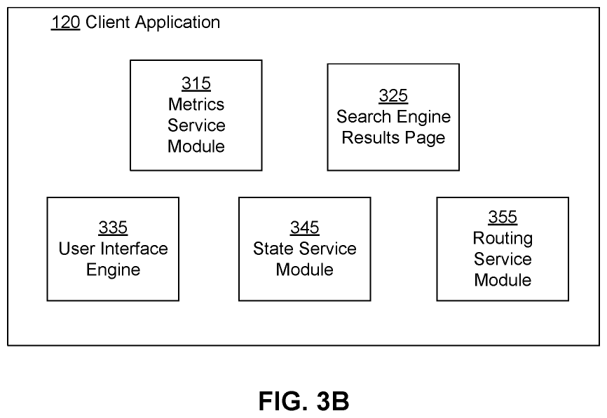

FIG. 3A shows the system architecture of a client application, in accordance with an embodiment. The client application 120 comprises a markup language rendering module 320, a search user interface 330, a server interaction module 340, and a local ranking module 350.

Data travels between the client application 120 and the online system 100 over the network 150. This is facilitated on the client application 120 side by the server interaction module 340. The server interaction module 340 connects the client application 120 to the network and establishes a connection with the online system 100. This may be done using file transfer protocol, for example, or any other computer network technology standard, or custom software and/or hardware, or any combination thereof.

The search user interface 330 allows the user to interact with the client application 120 to perform search functions. The search user interface 330 may comprise physical and/or on-screen buttons, which the user may interact with to perform various functions with the client application 120. For example, the search user interface 330 may comprise a query field wherein the user may enter a search query, as well as a results field wherein search results are displayed. In an embodiment, users may interact with search results by selecting them with a cursor.

The markup language rendering module 320 works with the server interaction module 340 and the search user interface 330 to present information to the user. The markup language rendering module 320 processes data from the server interaction module 340 and converts it into a form usable by the search user interface 330. In one embodiment, the markup language rendering module 320 works with the browser of the client application 120 to support display and functionality of the search user interface 330.

FIG. 3B shows the system architecture of a client application, in accordance with an embodiment. As shown in FIG. 3B, the client application comprises a metrics service nodule 315, a search engine results page 325, a UI (user interface) engine 335, a state service module 345, and a routing service module 355. Other embodiments may include different modules than those indicated here.

Client applications are becoming increasingly complicated. The state service module 345 manages the state of the application. This state may include responses from server side services and cached data, as well as locally created data that has not been yet sent over the wire to the server. The state may also include active actions, state of current view, pagination and so on.

The metrics service nodule 315 provides APIs for instrumenting user interactions in a modular, holistic and scalable way. It may also offer ways to measure and instrument performance of page views. It collects logging events from various views within the client application. It may batch all these requests and send it over to instrumentation service module 135 for generating the persisted log lines in app log store 165.

The UI engine 335 efficiently updates and renders views for each state of the application. It may manage multiple views, event handling, error handling and static resources. It may also manage other aspects such as localization.

The routing service module 355 manages navigation within different views of the application. It contains a map of navigation routes and associated views. It usually tries to route application to different views without reloading of the entire application.

The search engine results page 325 is used by the user to conduct searches to satisfy information needs. User interacts with the interface by issuing a search query, then reviewing the results presented on the page to determine which or if any results may satisfy user's need. The results may include documents of one or more entity types. Results are typically grouped by entities and shown in the form of sections that are ordered based upon relevance.

In one embodiment, the online system uses neural networks to extract feature vectors representing users. The various features of the feature vectors represent dimensions of a multi-dimensional space. The online system determines user clusters based on the extracted feature vectors. The online system determines a cluster matching a user by determining a feature vector corresponding to the user and then comparing it with aggregate feature vectors corresponding to the user clusters. The user cluster that corresponds to the best match between the user's feature vector and the aggregate feature vector of the user cluster represents the matching user cluster for the user.

FIG. 4 shows a diagram of an example neural network that may be used for extracting feature vector for a user, in accordance with an embodiment. The neural network 410 is stored in a neural network store associated with the online system (e.g., online system 110). The neural network 410 includes an input layer 415, one or more hidden layers 420a-n, and an output layer 425. Each layer of the neural network 410 (i.e., the input layer 415, the output layer 425, and the hidden layers 420a-n) comprises a set of nodes such that the set of nodes of the input layer 415 are input nodes of the neural network 410, the set of nodes of the output layer 425 are output nodes of the neural network 410, and the set of nodes of each of the hidden layers 420a-n are hidden nodes of the neural network 410. Generally, nodes of a layer may provide input to another layer and may receive input from another layer. Nodes of each hidden layer are associated with two layers, a previous layer, and a next layer. The hidden layer receives the output of the previous layer as input and provides the output generated by the hidden layer as input to the next layer.

Each node has one or more inputs and one or more outputs. Each of the one or more inputs to a node comprises a connection to an adjacent node in a previous layer and an output of a node comprises a connection to each of the one or more nodes in a next layer. That is, each of the one or more outputs of the node is an input to a node in the next layer such that each of the node is connected to every node in the next layer via its output and is connected to every node in the previous layer via its input. Here, the output of a node is defined by an activation function that applies a set of weights to the inputs of the nodes of the neural network 410. Example activation functions include an identity function, a binary step function, a logistic function, a Tan H function, an ArcTan function, a rectilinear function, or any combination thereof. Generally, an activation function is any non-linear function capable of providing a smooth transition in the output of a neuron as the one or more input values of a neuron change. In various embodiments, the output of a node is associated with a set of instructions corresponding to the computation performed by the node. Here, the set of instructions corresponding to the plurality of nodes of the neural network may be executed by one or more computer processors.

In one embodiment, the input vector 405 is a vector comprising features describing a user of the online system 110. Each feature represents a dimension in a multi-dimensional space. Accordingly, a user is represented as a data point in a multi-dimensional space represented using a plurality of dimensions such that each dimension represents a user profile attribute (e.g., user profile attributes stored in a user profile or user account of the user). In an embodiment, the plurality of dimensions comprise a dimension representing a rate of user interactions by the user with records of a particular entity type. In an embodiment, the plurality of dimensions comprise a dimension representing a role of the user in an organization. The online system may use the input vector 405 directly for clustering users and for matching users against clusters to find a matching cluster. Alternatively, the online system may provide the input vector 405 to a neural network and extract a feature vector from a hidden layer of the neural network for clustering users and matching users against user clusters.

The neural network 410 generates as output comprising value, or a score. An output generated by the neural network 410 is, for example, a score indicating a likelihood of the input user interacting with an entity of a particular entity type when presented with a plurality of entities of various types. The hidden layer 420n of the neural network 410 generates a numerical vector representation of an input vector also referred to as an embedding. The numerical vector is a representation of the input vector mapped to a latent space. The online system uses the output of a hidden layer 420 as the feature vector representing an input user. In an embodiment, the online system extracts the output of the last hidden layer 420n that provides input to the output layer 425 and uses it as the feature vector for an input user.

The connections between nodes in the neural network 410 each include a weight. In one or more embodiments, training the neural network 410 comprises adjusting values for weights of the neural network 410 to minimize or reduce a loss function associated with the neural network 410. Training the neural network 410 is further described below in conjunction with FIG. 5. In an embodiment, the neural network 410 used to extract user feature vectors is a multilayer perceptron.

FIG. 5 shows an example system architecture of a neural network module 280 for generating feature vectors describing users, in accordance with an embodiment. In FIG. 5, the neural network module 280 comprises a DNN 530, a training data store 520, a training module 540, and a user embedding selection module 545. The DNN 530 comprises various components including a user neural network 535b and search query neural network 535c that are trained in parallel and provide their output to a result neural network 535a. Each of the components of the DNN, i.e., neural networks 535a, 535b, and 535c represent an embodiment of the neural network 280. In other embodiments, the system architecture 500 may include additional or fewer modules than those shown in FIG. 5. Furthermore, specific functionality may be implemented by modules other than those described herein. In some embodiments, various neural networks illustrated in FIG. 5 may be executed by different online systems 110. For example, the neural networks 535 may be executed by one or more processors different from the processors associated with the modules described herein.

The user neural network 535b and the search query neural network 535c are each configured to receive an input vector and generate an output based on the received input vector. Generally, the output of both the user neural network 535b and the search query neural network 535c is some function of the received input vector. In the embodiment depicted in FIG. 5, the user neural network 535b is configured to receive, as an input, a user vector (e.g., a vector describing a user profile of a user) and the search query neural network 535c is configured to receive, as an input, a vector representing a search query. In an embodiment, each term of a search query is represented using one hot encoding.

The result neural network 455 is configured to receive, as inputs, the output generated by both the user neural network 535b and the search query neural network 535c. The neural network 455 is configured to generate an output associated with a user vector and a search query vector. In various embodiments, the neural network 455 changes the weights of user neural network 535b and search query neural network 535c based on various learning algorithms. Here, changing the weights of user neural network 535b and search query neural network 535c comprises adjusting the weights between individual neurons of the hidden layers to reduce a total measure of error between a predicted output and actual output. In an example embodiment, the neural networks 535 are configured to implement a backpropagation algorithm.

The training data store 520 stores a training dataset for training the DNN 530. The training dataset comprises labelled samples of data. Here, samples are associated with how a particular user of the online system as responded to search queries in the past. The labels assigned to each sample of data represent the expected output corresponding to the sample data. For example, the training data store 520 may include three columns, one for search query data, one for user data, and one for a label describing the entity type of the search result that the user clicked on responsive to being presented with the search results. The training data may be based on historical data or may be manually provided, for example, by an expert user interacting with the online system via a user interface configured to allow users to enter labels.

The training module 540 trains the DNN 530. In an embodiment, the training module 540 trains the DNN 530 by comparing the result of executing the DNN 530 for a sample input data with the expected label associated with the sample input data to determine a measure of error in the generated result. The errors observed in the generated results of various sample input data values are fed back into the DNN 530 to adjust the various weights associated with the nodes and the connections of the DNN 530 (e.g., a backpropagation algorithm). This process is repeated iteratively until an aggregate metric based on the error is determined to be below certain threshold value. The training module 540 repeats the process of training the DNN 530 through multiple iterations. The training process is typically performed offline.

The neural network module 280 is executed during an online processing when the online system receives events and identifies content items associated with the events for distributing to users. The online system provides user and search query data to the neural network 142 and neural network 144 to generate a user embedding 560. The user embedding 560 represents the sample input data at a layer within the neural network. An embedding is represented as a vector having one or more dimensions. A user embedding selection module 550 selects embeddings from a hidden layer of the neural network 142. In an embodiment, the user embedding selection module 445 select embeddings from the last hidden layer of the user neural network 535b. The user embedding selection module 550 provides the selected embeddings to the feature extraction module 240.

In an embodiment, the neural network module 280 receives a dataset in which most of the samples are unlabeled. In an iteration, the DNN 530 is trained on only the labeled samples from the original sample dataset. At the end of each iteration, the trained DNN 530 runs a forward pass on the entire dataset to generate embeddings representing sample data. The neural network module 280 labels the received unlabeled sample set and adds it to the labeled sample set, which is provided as input data for the next training iteration.

### System Processes

The processes associated with searches performed by online system 100 are described herein. The steps described herein for each process can be performed in an order different from those described herein. Furthermore, the steps may be performed by different modules than those described herein.

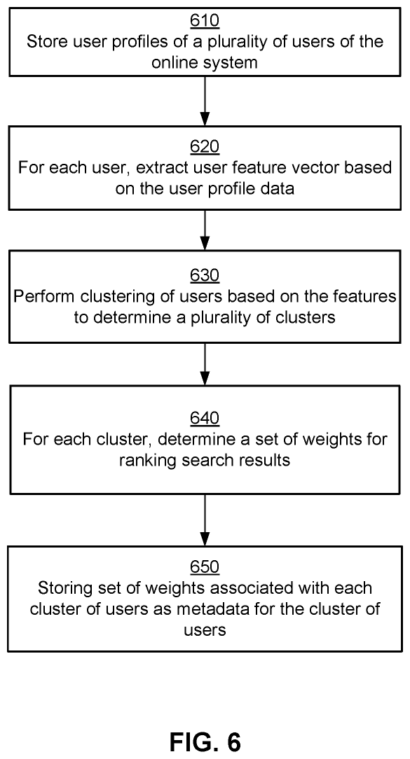

FIG. 6 illustrates a process for clustering users, in accordance with an embodiment. The online system 100 stores 610 user profiles for a plurality of users in the user profile store 275. The online system 100 extracts 620 user feature vectors for each of the plurality of users. Each user feature vectors is based on user profile data for a user. In an embodiment, each feature of the feature vector represents a value based on a user profile attribute. In another embodiment, the feature vector represents an embedding extracted from a neural network.

The clustering module 285 performs 630 clustering of users (or user profiles corresponding to users) based on the feature vectors representing the users. The clustering module 285 determines a plurality of clusters of users as a result of the clustering. The clustering module 285 stores information describing the clusters in the cluster metadata store 290. Information describing a cluster includes a cluster identifier and statistical information describing aggregate feature vectors for the cluster.

For each cluster, the online system 100 determines 640 a set of weights that are used for ranking of search results. In an embodiment, at least some of the weights from the set of weights are associated with entity types and indicate a likelihood of user interacting with an entity of that entity type from search results. In another embodiment, the online system 100 trains a machine learning model for each cluster, wherein the machine learning model is configured to generate a score used for ranking search results. For example, the machine learning model may receive as set of search results as input and generate scores indicating relevance of each search result. The online system stores the set of weights for each cluster as metadata in the cluster metadata store 290.

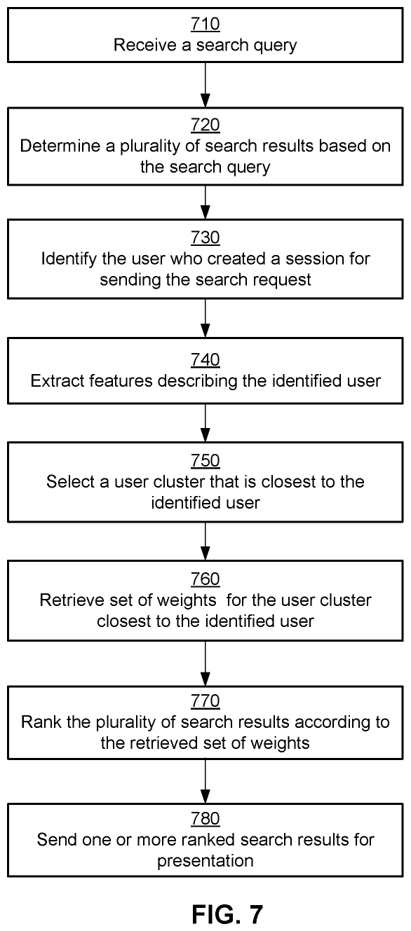

FIG. 7 illustrates the process of ranking search results based on user information, in accordance with an embodiment.

The online system 100 receives 710 a search query and processes it. The search query may be received from a client application 120 executing on a client device 110 via the network 150. In some embodiments, the search query may be received from an external system, for example, another online system via a web service interface provided by the online system 100. The search query comprises a set of search criteria, as detailed supra. The query execution module 220 determines 720 a plurality of search results matching the search query. In an embodiment, the search results represent entities obtained from the object store 160, each entity having an entity type.

In an embodiment, a user creates a session with online system 100 via a client device 110. For example, the user may provide credential such as a user identifier and a password to connect with the online system 100 and then send requests for data to the online system 100. An example, of a user identifier is an email address of the user or a unique alpha numeric string used for uniquely identifying the user in the online system 100. The online system 100 identifies 730 the user who created the session used for sending the search request. The online system 100 may retrieve a user profile or a user account describing the user from the user profile store 275 based on the user identifier.

The online system 100 extracts 740 features describing the identifier user. In an embodiment, the feature extraction module 240 extracts a feature vector based on various attributes of the user profile. In another embodiment, the features are extracted by the feature extraction module 240 by providing user profile information as input to a neural network and extracting an embedding representing a user feature vector from a hidden layer of the neural network.

The online system 100 selects 750 a user cluster that is closest to the identified user. In an embodiment, the online system 100 stores a feature vector representing a centroid of each cluster. The online system determines a distance between the feature vector of the user sending the search request and feature vectors representing centroids of user clusters. The online system 100 compares the various distance values and selects the user cluster corresponding to the smallest distance value. The distance between two vectors may be a Euclidean distance or any other distance measure, for example, Hamming distance or Manhattan distance.

The search module 130 retrieves 760 a set of weights for the selected user cluster. In an embodiment, the set of weights represent an entity type relevance score that indicates a likelihood of a user interacting with a record of that entity type from the search results returned. In an embodiment, the online system determines the entity type relevance score for an entity type as an aggregate of the number of user interactions performed by users with entities of that entity type returned as search results over a plurality of search requests. The aggregate value may represent the percentage of user interactions performed with entities of that particular entity type returned as search results as compared to the total number of user interactions performed by users aggregated over all entity types. Hence, the online system implements a ranking scheme or model comprising weighting search results by entity type for each cluster of similar search queries. The search result ranking module 230 ranks 770 the search results according to the ranking scheme or model, based at least in part on entity type relevance scores. For example, for a given user cluster, if search results of entity type “Account” historically result in more user interactions than search results of entity type “Case” for search queries from that cluster, then subsequent search queries are likely to rank search results comprising entity type “Account” higher than search results of entity type “Case.”

In an embodiment, the set of weights represents a machine learning based model for ranking search results. The entity type is incorporated as a feature in the machine learning based model. The search module 130 identifies a machine learning based model corresponding to the cluster of users matching the user profile of the user sending the search query and applies it to the search results. The search module 130 uses the machine learning based model to determine the relevance score for each search result.

The search module 130 ranks 770 the search results based on the relevance scores, for example in descending order by relevance score from greatest to least. The search module 130 sends 660 the ranked search results to the requestor. If the online system 100 ranks the search results, the online system sends the ranked search results are over the network 150 to the client application 120, where the ranked search results are then sent for display.

In an embodiment, the online system is a multi-tenant system and user clusters and the set of weights for each user cluster are determined for each tenant separately.

### Computer Architecture

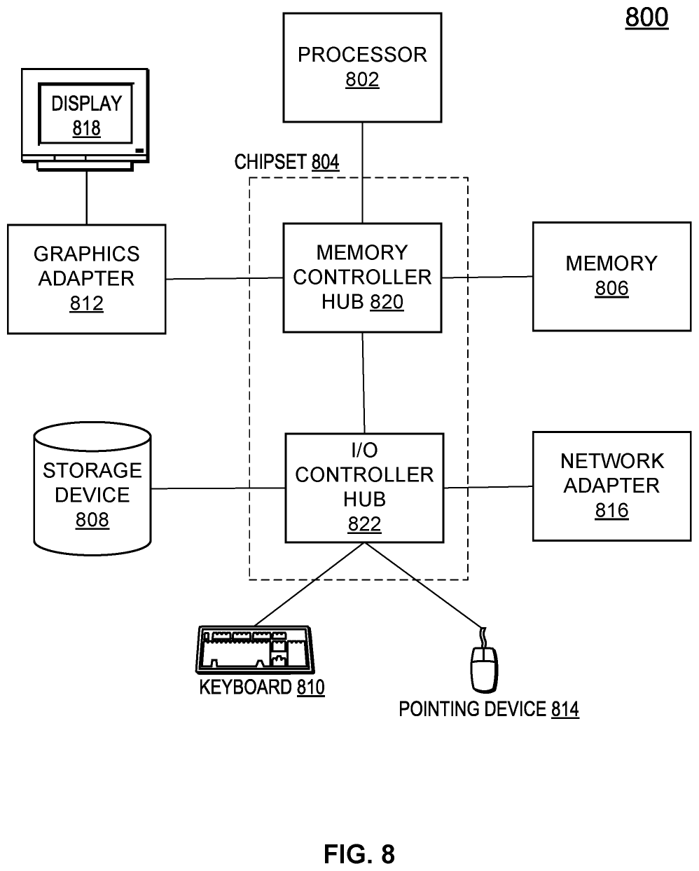

The entities shown in FIG. 1 are implemented using one or more computers. FIG. 8 is a high-level block diagram of a computer 800 for processing the methods described herein. Illustrated are at least one processor 802 coupled to a chipset 804. Also coupled to the chipset 804 are a memory 806, a storage device 808, a keyboard 810, a graphics adapter 812, a pointing device 814, and a network adapter 816. A display 818 is coupled to the graphics adapter 812. In one embodiment, the functionality of the chipset 804 is provided by a memory controller hub 820 and an I/O controller hub 822. In another embodiment, the memory 806 is coupled directly to the processor 802 instead of the chipset 804.

The storage device 808 is any non-transitory computer-readable storage medium, such as a hard drive, compact disk read-only memory (CD-ROM), DVD, or a solid-state memory device. The memory 806 holds instructions and data used by the processor 802. The pointing device 814 may be a mouse, track ball, or other type of pointing device, and is used in combination with the keyboard 810 to input data into the computer system 800. The graphics adapter 812 displays images and other information on the display 818. The network adapter 816 couples the computer system 800 to the network 150.

As is known in the art, a computer 800 can have different and/or other components than those shown in FIG. 8. In addition, the computer 800 can lack certain illustrated components. For example, the computer acting as the online system 100 can be formed of multiple blade servers linked together into one or more distributed systems and lack components such as keyboards and displays. Moreover, the storage device 808 can be local and/or remote from the computer 800 (such as embodied within a storage area network (SAN)).

As is known in the art, the computer 800 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 808, loaded into the memory 806, and executed by the processor 802.

### Alternative Embodiments

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

It is to be understood that the figures and descriptions have been simplified to illustrate elements that are relevant for a clear understanding of the present invention, while eliminating, for the purpose of clarity, many other elements found in a typical online system. Those of ordinary skill in the art may recognize that other elements and/or steps are desirable and/or required in implementing the embodiments. However, because such elements and steps are well known in the art, and because they do not facilitate a better understanding of the embodiments, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the various embodiments. This description should be read to include one or at least one and the singular also includes the plural unless it is obvious that it is meant otherwise.

Upon reading this disclosure, those of skill in the art will appreciate still additional alternative structural and functional designs for a system and a process for displaying charts using a distortion region through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

We claim:

1. A computer implemented method for ranking search results, the method comprising:
receiving, by an online system, a search query via a session created by a user via a client device, the search query requesting matching records, wherein each record has one of a plurality of entity types;
determining a plurality of search results matching the search query, each search result associated with a record, wherein the online system stores records, each record having an entity type;
identifying a user profile describing the user that created the session;
determining a feature vector based on the user profile of the user, the feature vector comprising a plurality of features, each feature representing a dimension from a plurality of dimensions;
comparing the feature vector with each of a plurality of clusters of user profiles, wherein a cluster of user profiles represents similar users based on a matching along the plurality of dimensions;
selecting based on the comparison, a cluster of users matching the feature vector of the user profile;
accessing a set of weights associated with the selected cluster of user profiles;
ranking the plurality of search results based on the set of weights; and
returning one or more ranked search results for display via the client device.

2. The method of claim 1, wherein determining the feature vector comprises extracting the feature vector from a hidden layer of a neural network, the neural network configured to receive an encoding of a given user profile.

3. The method of claim 2, wherein the neural network is configured to generate a score indicative of a likelihood of a user having the given user profile interacting with an entity of a particular entity type.

4. The method of claim 2, wherein the neural network is trained using past user interactions of users with records of a particular entity type responsive to the user being presented with a plurality of records of various entity types.

5. The method of claim 2, wherein the neural network is trained to receive an encoding of an input user profile and an encoding of an input search query and determine a likelihood of the user having the given user profile interacting with a search result of a particular entity type responsive to being presented with a plurality of search results, each search result corresponding to an entity type.

6. The method of claim 1, wherein the plurality of dimensions comprise one or more dimensions, each of the one or more dimensions representing a user profile attribute.

7. The method of claim 1, wherein the plurality of dimensions comprise a dimension representing a rate of user interactions by the user with records of a particular entity type.

8. The method of claim 1, wherein the plurality of dimensions comprise a dimension representing a role of the user in an organization.

9. The method of claim 1, further comprising:
extracting feature vectors for a plurality of users;
clustering the feature vectors to generate a plurality of clusters, each cluster representing users that have similar feature vectors;
for each cluster, determining a set of weights for ranking records of various entity types; and
storing the set of weights for each of the plurality of clusters of users.

10. The method of claim 1, wherein each cluster of users is associated with a centroid of feature vectors of the users of the cluster, wherein selecting the cluster of users matching the feature vector of the user profile comprises comparing distances between the feature vector of the user profile and each of the centroids of feature vectors corresponding to the plurality of clusters and selecting the cluster with the smallest distance.

11. The method of claim 1, wherein the set of weights comprise weights representing relevance scores for entity types, the relevance score for a particular entity type indicative of a likelihood of a user interacting with a record of the particular entity type.

12. The method of claim 1, wherein the set of weights represent a machine learning model for ranking search results returned by an input search query.

13. A non-transitory computer-readable storage medium storing computer program instructions executable by a processor to perform operations comprising:
receiving, by an online system, a search query via a session created by a user via a client device, the search query requesting matching records, wherein each record has one of a plurality of entity types;
determining a plurality of search results matching the search query, each search result associated with a record, wherein the online system stores records, each record having an entity type;
identifying a user profile describing the user that created the session;
determining a feature vector based on the user profile of the user, the feature vector comprising a plurality of features, each feature representing a dimension from a plurality of dimensions;
comparing the feature vector with each of a plurality of clusters of user profiles, wherein a cluster of user profiles represents similar users based on a matching along the plurality of dimensions;
selecting based on the comparison, a cluster of users matching the feature vector of the user profile;
accessing a set of weights associated with the selected cluster of user profiles;
ranking the plurality of search results based on the set of weights; and
returning one or more ranked search results for display via the client device.

14. The non-transitory computer-readable storage medium of claim 1, wherein determining the feature vector comprises extracting the feature vector from a hidden layer of a neural network, the neural network configured to receive an encoding of a given user profile.

15. The non-transitory computer-readable storage medium of claim 14, wherein the neural network is configured to generate a score indicative of a likelihood of a user having the given user profile interacting with an entity of a particular entity type.

16. The non-transitory computer-readable storage medium of claim 14, wherein the neural network is trained to receive an encoding of an input user profile and an encoding of an input search query and determine a likelihood of the user having the given user profile interacting with a search result of a particular entity type responsive to being presented with a plurality of search results, each search result corresponding to an entity type.

17. The non-transitory computer-readable storage medium of claim 13, wherein each cluster of users is associated with a centroid of feature vectors of the users of the cluster, wherein selecting the cluster of users matching the feature vector of the user profile comprises comparing distances between the feature vector of the user profile and each of the centroids of feature vectors corresponding to the plurality of clusters and selecting the cluster with the smallest distance.

18. The non-transitory computer-readable storage medium of claim 13, wherein the set of weights comprise weights representing relevance scores for entity types, the relevance score for a particular entity type indicative of a likelihood of a user interacting with a record of the particular entity type.

19. The non-transitory computer-readable storage medium of claim 13, the operations further comprising:
extracting feature vectors for a plurality of users;
clustering the feature vectors to generate a plurality of clusters, each cluster representing users that have similar feature vectors;
for each cluster, determining a set of weights for ranking records of various entity types; and
storing the set of weights for each of the plurality of clusters of users.

20. A computer system comprising:
one or more electronic processors; and
a non-transitory computer-readable storage medium storing computer program instructions executable by a processor to perform operations comprising:
receiving, by an online system, a search query via a session created by a user via a client device, the search query requesting matching records, wherein each record has one of a plurality of entity types;
determining a plurality of search results matching the search query, each search result associated with a record, wherein the online system stores records, each record having an entity type;
identifying a user profile describing the user that created the session;
determining a feature vector based on the user profile of the user, the feature vector comprising a plurality of features, each feature representing a dimension from a plurality of dimensions;
comparing the feature vector with each of a plurality of clusters of user profiles, wherein a cluster of user profiles represents similar users based on a matching along the plurality of dimensions;
selecting based on the comparison, a cluster of users matching the feature vector of the user profile;
accessing a set of weights associated with the selected cluster of user profiles;
ranking the plurality of search results based on the set of weights; and
returning one or more ranked search results for display via the client device.
